(19) United States
(12) Patent Application Publication
(10) Pub. No.: US 2008/0073000 A1
(43) Pub. Date: Mar. 27, 2008

(54) Soldering flux, solder paste, and flux cored solder

(76) Inventors: Takuya Ikeda, Nishinomiya-shi (JP); Takeshi Tanaka, Ikeda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/730,310

(22) Filed: Mar. 30, 2007

(30) Foreign Application Priority Data
Sep. 22, 2006 (JP) 2006-256942
Nov. 11, 2006 (JP) 2006-306068

(51) Int. Cl. B23K 35/363

(52) U.S. Cl. 148/24

(57) ABSTRACT

With solder paste, the active agent and the alloy in the flux react during storage and the paste changes in quality. Solder paste with an altered quality is no longer appropriate for use in printing, for example. Further, active agent unable to escape after the alloy is melted is vaporized and produces voids, or remains in the residue and lowers the electrical reliability. Hydrotalcite is contained in a flux used for solder paste. Hydrotalcite can intercalate an active agent that is anionic within its layered main chain, so that the active agent does not react with the alloy during storage of the solder paste. The solder paste thus shows excellent storability and printing stability. Through heating, the active agent is separated from the main chain and can function as an active agent. The active agent is reincorporated when the alloy hardens, making it possible to reduce the number of voids, and, even if the active agent is present in the residue, it does not adversely affect the electrical reliability.

### BACKGROUND OF THE INVENTION

1. Field of the Invention

The present invention relates to flux for solder alloy solder paste, and to solder pastes using this flux. In particular, the invention relates to low-lead or leadless solder pastes.

2. Description of Related Art

Conventionally, a tin-lead alloy has been used as the solder alloy in solder pastes that are used to bond electronic components to printed circuit boards. Environmental concerns have created a demand for solder alloys that do not contain lead, and tin-silver, tin-copper, tin-silver-copper, tin-bismuth, tin-antimony, tin-indium, and tin-zinc leadless solders, for example, have come into use.

Conventional tin-lead based solder is stable because tin and lead have very close potentials, but in lead-free solder there is a potential difference between tin and silver, copper, and zinc, and this causes the base metals to be oxidized when the solder metal comes into contact with oxygen. This oxide film must be removed in order to carry out bonding by soldering, and therefore it is necessary to use a strong active agent as the flux.

However, because tin and zinc are highly reactive, they react with active agents in the flux during storage or prior to solder mounting. As a result, the storage and printing stability of the solder paste degrade. Here, degradation in the printing stability refers to the fact that the paste is rolled by the back and forth motion of a squeegee on the mask and changes over time.

Further, the melting temperature is higher than in conventional tin-lead based solder, and thus bubbles produced from the flux during melting cannot escape and become voids that lower the bond strength, particularly at fine pitches.

Also, since the amount of active agent required in the flux is greater than in tin-lead based solder, the electrical reliability after mounting tends to be poor.

To solve these problems, one conventional approach has been to increase the stability by mixing an additive in with the flux, whereas another approach has been to create a protection layer on the surface of the solder alloy in order to inhibit the reaction between the flux and the solder alloy.

One example of the former approach is a flux containing a 1 to 50 mass % resin that has a carboxylic acid group and a softening point of 100° C. or lower, an organic amine that has an acid dissociation constant (pKa) in the range of 10.0 to 11.5 and a boiling point in the range of 50° C. to 200° C., and a non-ionic organic halide, wherein the overall pH of the flux is in the range of 4 to 9 (see JP 2003-001487A). Other examples include a flux compound in which an oxetane compound is added (see JP 2004-202518A) and a solder paste in which at least one type of organic acid ester that decomposes to produce an acid and an ester decomposition catalyst are blended (see JP H11-197879A).

Examples of the latter approach that have been proposed include coating the surface of alloy particles that contain zinc with a rust preventive or another metal (see JP H09-001382A), forming a protective film of magnesium oxide on the surface of an alloy of tin and zinc (see JP 2004-082134A), and creating a slightly soluble metal salt on the surface of solder alloy powder (see 2003-126991A).

The intended goal of the approach to stabilize the paste by adding an additive to the flux is to inhibit to a certain extent the reaction between active agents in the flux and the alloy to be reacted, so this leads to degradation in the effectiveness of the active agents that are used. These additives remain as flux residue even after bonding, and thus have the potential to lower the electrical and mechanical reliability.

Problems with providing a protection layer on the surface of the alloy or modifying the surface are that each alloy requires a different processing method, and it is necessary to confirm the compatibility between the protection layer and the flux. Additionally, this method has hardly any effect on the voids originating from bubbles produced from the active agents.

Moreover, even when these methods are adopted, the paste becomes unstable and its storability lowers when a highly reactive active agent is used. For this reason, it has been necessary to exercise extra care when handling, including the need for cooling during storage and supplying only a small amount of the paste to the printing equipment when printing circuit boards.

### BRIEF SUMMARY OF THE INVENTION

It is an object of the invention is to solve the issues of storage stability, printing stability, overheating stability, lowering the production of voids, and the degradation in electrical reliability after mounting due to flux residue.

In order to solve the foregoing issues, the present invention involves the inclusion of an active agent and hydrotalcite in the flux. The hydrotalcite is a compound expressed by the following Formula (I):

[Mₘ²⁺Mₙ³⁺(OH)₂ₘ₊₂ₙ]X_{n/z}^{z-}.bH₂O (I)

wherein:

Mₘ²⁺ is a divalent ion of at least one metal selected from the group consisting of Mg, Ca, Sr, Cu, Ba, Zn, Cd, Pb, Ni, Zr, Co, Fe, Mn, and Sn;

Mₙ³⁺ is a trivalent ion of at least one metal selected from the group consisting of Al, Fe, Cr, Ga, Ni, Co, Mn, V, Ti, and In;

m and n are real numbers;

X_{n/z}^{z-} is a z-valence anion; and

b is a real number.

The invention also provides a solder paste containing the flux and a flux cored solder.

In this invention, hydrotalcite, which becomes a support agent for the active agent, is contained in the flux of the solder paste. For this reason, the organic acid or halogen-based compound (hereinafter, also referred to as “halide”) serving as the active agent is intercalated (inserted) into the hydrotalcite, and thus the alloy and the active agent in the solder paste do not react during storage or printing. As a result, it becomes possible to stably store and print the solder paste. Further, since the active agent is not consumed during storage or printing, the action by the active agent of removing the oxide film and improving the wettability of the solder is exhibited more effectively.

Moreover, when soldering is performed, the residual active agent that could not escape from the alloy is incorporated into the hydrotalcite before it is vaporized, and thus the number of voids is reduced.

Further, since the ions remaining in the flux as residue are incorporated, there is the effect that the electrical reliability after bonding also is increased.

### DETAILED DESCRIPTION OF THE INVENTION

Hydrotalcite is a compound whose structure is expressed by the general formula [Mₘ²⁺Mₙ³⁺(OH)₂ₘ₊₂ₙ]X_{n/z}^{z-}.bH₂O. Hydrotalcite is produced naturally and also can be readily synthesized. Here, hydrotalcite that is produced naturally will be called natural hydrotalcite, and hydrotalcite that has been synthesized will be called hydrotalcite-like compound. The two will be called hydrotalcite collectively. The hydrotalcite-like compound is basically a hydroxide, and therefore can be produced as a precipitate by mixing solutions of divalent and trivalent metal salts with an alkaline solution. This is called coprecipitation.

The main chain of the hydrotalcite structure is the [Mₘ²⁺Mₙ³⁺(OH)₂ₘ₊₂ₙ], and is a sheet-shaped metal hydroxide. This portion of the main chain is called the host. Anions and water molecules are intercalated between the layers of the sheet-shaped host. This is the X_{n/z}^{z-}.bH₂O portion, and is called the guest. Thus, the hydrotalcite-like compound is also called a layered double hydroxide (LDH) because its main chain is a double hydroxide with a layered structure. The X_{n/z}^{z-} is an anion and is produced from any one of at least a monobasic acid, a dibasic acid, and a halogen-based compound. Of course, it may also contain anions from a plurality of sources. The anion may also include chlorine ion, sulfate ion, or nitrate ion.

The layers of the hydroxide making up the main chain form a structure in which some of the divalent metal ions are substituted with trivalent metal ions, and thus overall they have a positive charge. Thus, the charge density of the layers of the main chain increases the greater the substitution by trivalent metal ions, and the electrical balance is maintained by the anion guest. In other words, hydrotalcite has the characteristic that electrically negative substances are readily intercalated between its layers as guests.

To put it differently, layered compounds such as hydrotalcite have the ability to exchange anions, and various molecules and ions may be intercalated between its layers. Ions with higher charge densities tend to be intercalated more easily.

It should be noted that, as described above, anions are readily incorporated within hydrotalcite because the charge balance in the host is on the positive side. Thus, it is not absolutely necessary for the Mₘ²⁺ and the Mₙ³⁺ in the main chain to be divalent and trivalent. In fact, it has been reported that hydrotalcite-like compounds have been synthesized through the combination of monovalent and trivalent, and divalent and tetravalent, metal ions. The present invention does not exclude such hydrotalcite-like compounds. For example, one example of a combination of monovalent and trivalent cations is the use of Li (monovalent) and Al (trivalent).

Consequently, the hydrotalcite-like compound that can be used in the invention is a layered hydroxide that contains metal ions with different valence numbers. More specifically, it is a layered double hydroxide. It is possible for there to be three or more metal ions with different valence numbers, and for example, combinations of monovalent, divalent, and trivalent metal ions, or divalent, trivalent, and tetravalent metal ions, are possible. For example, a compound in which two metal ions are present may be expressed by the following general formula (II):

[Mₘ^{α+}Mₙ^{β+}(OH)₂ₘ₊₂ₙ]X_{n/z}^{z-}.bH₂O, (II)

where α and β are integers, and are not the same number,

Mₘ^{α+} is at least one type of metal ion of a valency of α,

Mₙ^{β+} is at least one type of metal ion of a valency of β,

m and n are real numbers,

X_{n/z}^{z-} is a z-valent anion, and

b is a real number.

Of course, it is also possible for metal ions of one valence number to be constituted by a plurality of different metal ions, such as Mₘ^{α+} and Mₙ^{β+} being Mg²⁺ and Ca²⁺ when α is 2 and Al³⁺ and Fe³⁺ when β is 3. In a case where there are three types of metal ions, the number of metal ions with different valence numbers increases, as indicated by Mₘ^{α+}Mₙ^{β+}Mₒ^{γ+}. It should be noted that the term “metal” in this specification is meant to refer to all elements except for H (hydrogen), B (boron), C (carbon), N (nitrogen), O (oxygen), F (fluorine), S (sulfur), Cl (chlorine), Br (bromine), and the inert gases.

The anions incorporated as guests in the flux may be separated away by heating. Upon cooling, they are again incorporated between the layers of the main chain. The hydrotalcite-like compound exhibits a unique thermal decomposition behavior in regard to its anion guests.

The present invention attempts to solve the foregoing problems through the use of a hydrotalcite with these characteristics as the flux of a solder paste.

In other words, the organic acids and halides used as active agents have polar regions in their chain, and thus can be readily intercalated between the layers of the main chain as anion guests. Active agents incorporated in this way do not react with the alloy metals in the solder paste. Thus, the solder paste remains stable over time without causing changes such as a rise in the viscosity or a rise in the thixotropy.

In addition, when alloy metals in the paste melt due to heating, the active agents are released from between the layers and remove the oxide films of the alloy metals, and thus can achieve their intended role during soldering. Moreover, they are reincorporated into the main chain as anions when the alloy hardens, and thus the occurrence of voids is prevented, and, even if they remain as residue, they do not lower the electrical reliability.

The solder paste is made from solder alloy powder and flux, and the flux generally contains resin and solvent as essential components, and depending on the desired characteristics, it also contains active agents, thixo agents, antioxidants, surfactants, anti-foaming agents, or corrosion inhibitors. It should be noted that the flux of a flux cored solder may not contain a solvent in some cases.

The flux of the invention may be made from at least a base resin, an active agent, and a layered hydroxide, more specifically a layered double hydroxide, that contains hydroxyl groups and metal ions with different valence numbers. The flux of the invention may also contain solvents or additives. As for the valencies of the metal ions, combinations of divalent and trivalent ions are common, but other combinations also are possible. It should be noted that the hydroxide includes hydrotalcite.

As for the hydrotalcite that can be used in the invention, examples of natural hydrotalcites include hydrotalcite Mg₆Al₂(OH)₁₆CO₃.4H₂O and stichtite Mg₆Cr₂(OH)₁₆CO₃.4H₂O, pyroaurite Mg₆Fe(III)₂(OH)₁₆CO₃.4H₂O, and desautelsite Mg₆Mn(III)₂(OH)₁₆CO₃.4H₂O. It should be noted that (III) indicates the trivalent state.

When described as a combination of divalent and trivalent metal ions, the synthetic hydrotalcite-like compound is a compound that is expressed by the general formula [Mₘ²⁺Mₙ³⁺(OH)₂ₘ₊₂ₙ]X_{n/z}^{z-}.bH₂O. Here, Mₘ²⁺ is a divalent ion of at least one metal selected the group consisting of Mg (magnesium), Ca (calcium), Sr (strontium), Cu (copper), Ba (barium), Zn (zinc), Cd (cadmium), Pb (lead), Ni (nickel), Zr (zirconium), Co (cobalt), Fe (iron), Mn (manganese), and Sn (tin), and it is also possible for a plurality of different types of metal ions to be selected. Mₙ³⁺ is a trivalent ion of at least one metal selected the group consisting of Al (aluminum), Fe (iron), Cr (chromium), Ga (gallium), Ni (nickel), Co (cobalt), Mn (manganese), V (vanadium), Ti (titanium), and In (indium), and m and n are real numbers and X_{n/z}^{z-} is a z-valent anion. Thus, z is normally an integer from 1 to 3.

The ratio m:n is preferably in the range of from 8:1 to 3:2, and more preferably in the range of from 5:1 to 2:1. This is because when n is outside this range, the compatibility with the guests that are intercalated is altered, and they can no longer be intercalated appropriately.

Specific examples of hydrotalcite-like compounds that can be used include Mg₆Al₂(OH)₁₆CO₃.4H₂O, Mg_{4.5}Al₂(OH)₁₃CO₃.3.5H₂O, Mg_{4.5}Al₂(OH)₁₃CO₃, Mg₄Al₂(OH)₁₂CO₃.3.5H₂O, Mg₅Al₂(OH)₁₄CO₃.4H₂O, Mg₃Al₂(OH)₁₀CO₃.1.7H₂O, Mg₃ZnAl₂(OH)₁₂CO₃.wH₂O, Mg₃ZnAl₂(OH)₁₂CO₃, Mg₄Al₂(OH)₁₂CO₃.3H₂O, Mg_{3.5}Zn_{0.5}Al₂(OH)₁₂CO₃.3H₂O. It should be noted here that w is a real number. It should also be noted that the hydrotalcites listed here are merely illustrative examples, and are not to be construed as limiting.

The amount of hydrotalcite-like compound used is in the range of 0.5 wt % to 10 wt %, and preferably 1 wt % to 5 wt %, of the flux. When it is less than 0.5 wt %, there will be no effect on the electrical reliability, while when it is greater than 10 wt %, the basic value of the viscosity becomes too high and thus it becomes hard to use. This is because when the basic value of the viscosity is high, the percentage of filler in the flux becomes high, and as a result the viscosity also becomes high.

Examples of the base resin that can be used in the flux of the invention include: rosin-based resins such as gum rosin, wood rosin, tall oil rosin, modifications of these rosins and rosin esters; turpentine-based resins such as turpentine resin and turpentine phenol resin; and epoxy ester resins. The amount of base resin used is in the range of 3 wt % to 60 wt %, and preferably 5 wt % to 50 wt %, of the flux.

Examples of the compounds that may be used as active agents in the invention include organic acids and halides. An organic acid or halide may be used alone, or an organic acid and a halide may be used in combination. The amount of these used is in the range of 0.01 wt % to 20 wt %, and preferably 0.1 wt % to 10 wt %, of the flux. It is not particularly necessary for the active agent to be fluid, and it may also be a solid. Some of specific examples of the organic acids and halides that can be used in the invention are listed below. It should be noted, however, that the active agents that can be used in the invention are not limited to these illustrative examples.

Examples of the organic acid used in the invention include compounds with acidic functional groups, such as carboxylic acids, sulfonic acids, sulfinic acids, phenols, ethanol, thiols, acid imides, oximes, and sulfonamides.

Carboxylic acids that can be used have acyl groups with 1 to 24 carbon atoms. Specific examples include: carboxylic acids having a straight chain hydrocarbon group with 1 to 21 carbon atoms, such as formic acid, acetic acid, propionic acid, butyric acid, valeric acid, hexanoic acid, heptanoic acid, octanoic acid, pelargonic acid, caprinic acid, lauric acid, myristic acid, palmitic acid, stearic acid, and behenic acid; carboxylic acids having an unsaturated hydrocarbon group with 2 to 10 carbon atoms, such as acrylic acid and methacrylic acid; monobasic acids such as carboxylic acids having a benzoyl group, such as benzoic acid; dibasic acids having a straight chain hydrocarbon group with 2 to 20 carbon atoms, such as oxalic acid, malonic acid, succinic acid, glutaric acid, adipic acid, pimelic acid, suberic acid, azelaic acid, sebacic acid, dodecadiacid, and eicosadiacid; dibasic acids having an unsaturated hydrocarbon group with 2 to 10 carbon atoms, such as maleic acid and fumaric acid; and dibasic acids having a phthalyol group such as phthalic acid.

Sulfonic acids are expressed by the general formula RSO₃H and may include both aromatic sulfonic acids, in which R is aromatic, and aliphatic sulfonic acids, in which R is aliphatic. Sulfinic acids are expressed by the general formula RSO₂H, and may include both aromatic sulfinic acids, in which R is aromatic, and aliphatic sulfinic acids, in which R is aliphatic. Phenols are compounds in which a hydrogen on an aromatic ring such as a benzene ring is substituted by a hydroxyl group. Thiols are compounds expressed by the general formula RSH, and include chain aliphatic thiols such as methanethiol and ethanethiol, cyclic-chain aliphatic thiols, such as cyclohexanethiol, and aromatic thiols such as mercaptobenzoic acid. Sulfonamides are compounds expressed by RSO₂NH₂ or SO₂NHR1. It should be noted that S indicates sulfur, O indicates oxygen, and H indicates hydrogen.

Examples of the halides include organic halides in which a hydrogen on a hydrocarbon is substituted by any halogen among fluorine, chlorine, bromine, and iodine, and compounds produced by the formation of a salt between a basic organic nitrogen compound such as an amine, pyridine, and quinoline, and any one hydrogen halide of fluorine, chlorine, bromine, or iodine. Examples of the organic halides include trans-2,3-dibromo-2-butene-1,4-diol, tetrabromomethane, 2,3-dibromopropionic acid, 2,3-dibromo-1-propanol, 2,2-bis(bromomethyl)-1,3-propanediol, tetrabromobisphenol A, and decabromodiphenyl oxide. Examples of the salts of an organic nitrogen compound and a hydrogen halide include diphenylguanidine.HBr, cyclohexylamine.HBr, diethylcyclohexylamine.HBr, diethylamine.HBr, and isopropylamine.HBr. It should be noted that in the above description, diphenylguanidine.HBr, for example, indicates the hydrogen bromide salt of diphenylguanidine. The organic acids and halides listed above are illustrative examples only, and are not intended to be limiting.

Compounds that can be used as the solvent are those normally used in flux, such as hexylene glycol, butyl glycol, hexyl diglycol, and terpineol. The amount of solvent used is in the range of 20 wt % to 80 wt %, preferably 30 wt % to 60 wt %, of the flux.

Compounds that may be used as the thixo agent include monoamide-, bisamide-, and substituted urea-based compounds. Hardened castor oil or the like is often used. The amount of the thixo agent used is in the range of 1 wt % to 20 wt %, preferably 5 wt % to 10 wt %, of the flux.

Examples of the solder power alloy that can be used when producing the solder paste include tin-silver, tin-copper, tin-silver-copper, tin-bismuth, tin-antimony, tin-indium, and tin-zinc based leadless solders.

The flux of the invention is fabricated by introducing base resin, thixo agent, active agent, and hydrotalcite into solvent, heating and agitating to dissolve, and then cooling to arrive at the flux of the invention. When these materials are introduced, it is possible to put in other additives as well. For the active agent it is possible to use an organic acid or a halide either alone or in combination. It is also possible to introduce other active agents as well.

It is also possible to premix the hydrotalcite, the halide, and the organic acid, to create a product in which these are intercalated as guests in the hydrotalcite. For example, the halide and the organic acid active agents are dissolved in the solvent for intercalation, and the hydrotalcite is introduced to this and agitated. By doing this, the active agents are intercalated in the hydrotalcite. It should be noted that the active agent may comprise both a halide and an organic acid, or only one of them. Further, it is also possible to perform processing such as applying heat when intercalation is performed. There are no particular limitations regarding the solvent for the intercalation, as long as the solvent can dissolve the active agents.

The hydrotalcite with intercalated active agent is then recovered by filtration. When a solder paste is produced using this hydrotalcite, the amount of residual organic acid or halide that has not been intercalated becomes less, and this further increases the stability of the solder paste. The hydrotalcite in which the active agents that have been intercalated could be called a functional active agent.

The flux thus created and the solder powder alloy are then agitated and dispersed by a mixer. In this way, the solder paste of the invention can be obtained.

The solder paste obtained in the foregoing manner is tested and evaluated in terms of the following items. The viscosity of the paste is evaluated by a spiral viscosity meter (10 revolution) according to JIS Z 3284 Appendix 6, the electrical reliability is evaluated according to JIS Z 3284 Appendices 3 and 14, and an overheat test was performed according to JIS Z 3284 Appendix 8. The test for voids was performed by placing a QFP (Quad Flat Package) on a test circuit board printed with the solder paste and reflowing, and then observing the void rate (percent area) with an X-ray transmission apparatus.

Specific methods of the above tests are described in detail below. The viscosity of the paste was assessed by a spiral viscosity meter (10 revolution) of JIS Z 3284 Appendix 6. The structure of the spiral-type viscosity meter used here has an outer cylinder that rotates and an inner cylinder with a spiral groove that is stationary, in which solder paste stuck in the spiral groove and in the gap between the inner and outer cylinders and advances from the introduction opening in conjunction with rotation of the outer cylinder, gradually moving up the groove and is discharged from the discharge port. The sheering stress that the solder paste experiences at this time is detected as the torque experienced by the inner cylinder, and the viscosity characteristics are found from the number of revolutions of the outer cylinder.

The measurement procedure is as follows.

(1) The solder paste is set aside for 2 to 3 hours at room temperature or 25° C.

(2) The lid of the solder paste container is opened and the contents are carefully mixed with a spatula for 1 to 2 minutes, being careful that air is not mixed in.

(3) The solder paste container is placed in a thermostatic chamber.

(4) The rotation speed of the spiral viscosity meter is adjusted to 10 rpm (rounds per minute), the temperature is set to 25° C., and approximately 3 minutes later after it is confirmed that the solder paste drawn out by the rotor has appeared from the discharge port, the rotor is stopped and the operator waits until a constant temperature is reached.

(5) After the temperature has been adjusted, the speed is adjusted to 10 rpm and the viscosity value is read after 3 minutes.

The electrical reliability is evaluated by an insulation resistance test according to JIS Z 3284 Appendices 3 and 14. A predetermined comb-shaped electrode circuit board is used for the insulation test. This is a glass-fabric-substrate-material epoxy resin copper-clad laminate, and has the shape of 20 comb-teeth shaped electrodes overlapped between 21 comb-teeth shaped electrodes. In the electrode overlap regions, the conductor width is 0.318 mm, the conductor pitch is 0.318 mm, and the side-by-side overlap is 15.75 mm.

Using a 100-μm thick metal plate provided with slits that match the electrode pattern for the overlapped electrode portion of this comb-shaped electrode, the solder paste is printed uniformly approximately 100-μm thick.

This is placed in a dryer set to 150° C. for two minutes, then the solder paste is melted for 30 seconds on a hot plate kept at 260° C. (after the solder melts it is kept liquid for at least 15 seconds). This is then allowed to cool, and served as a test piece.

A coaxial cable is used for the wiring to the electrodes, and before being placed in a temperature humidity controlled chamber, the insulation resistance between the terminals is measured using an insulation resistance meter at a test voltage DC 100 V (direct current of 100 volts).

The test piece is placed in a temperature humidity controlled chamber at a temperature of 85±2° C. and a relative humidity of 85% to 90%, being careful that condensed water droplets do not fall on the comb-shape pattern surface. 48 hours and 1000 hours after being introduced, the insulation resistance is measured at DC 100 V, with the test piece remaining in the chamber.

A migration test is performed according to JIS Z 3284 Appendix 14. Creation of the test piece, the electrode wiring, and the thermo-hygrostat conditions are the same as when testing the electrical reliability. After placing the test piece in the thermo-hygrostat, a voltage of 45 V to 50 V is applied between the electrodes.

This is set aside and removed from the thermo-hygrostat after 1000 hours, and the migration is observed using a magnifying glass (at least 20× zoom factor). It should be noted that here, migration refers to electromigration, and is the phenomenon where metal components move over and through a non-metal medium due to the effects of an electric field. Accordingly, whether or not sections of the solder region between the comb-shaped electrodes have moved is checked with a magnifying glass. In the examples discussed later, the insulation resistance was also measured at DC 100 V.

An overheat test is performed according to JIS Z 3284 Appendix 8. That is, solder paste is printed using a stencil having a constant printing aperture pattern, and evaluation is conducted to see to what distance the solder paste spreads outward when overheated.

The pattern of the stencil is as follows. The width of the apertures is 3.0×0.7 mm. These apertures are disposed in 0.1 mm increments from 0.2 mm to 1.2 mm. Specifically, there is an initial aperture, 0.2 mm next to which a second aperture is located, 0.3 mm after which a third aperture is located, and thereafter, the spacing between apertures grows successively larger. Since there are eleven apertures spaced 0.2 mm to 1.2 mm apart, in total there are 12 apertures provided. The stencil is provided with four such rows. The stencil is a stainless steel plate 0.2±0.001 mm thick.

First, the copper-clad laminate is polished with polishing paper and washed with isopropyl alcohol. Next, the stencil is placed on the copper-clad laminate, and the solder paste is printed using an appropriate squeegee. The stencil is then removed. In an air-circulated heating furnace, the printed test board is heated for one minute at 150° C. In this case, since the solder is tin-silver-copper (Sn 96.5 wt %, Ag 3.0 wt %, Cu 0.5 wt %) based solder, the heating temperature is 150° C. However, to perform the test under more severe conditions, the test was carried out at 200° C. in the examples discussed below.

Of the four rows of the pattern, the minimum spacing at which all of the printed solder paste does not become a single unit is defined as the overheat value. For example, an overheat value of 0.2 means that heating does not cause the solder paste to come into contact with the adjacent solder paste even when the solder paste has been printed at a 0.2 mm pitch.

### Embodiment 1

Hereinbelow, working samples and comparative samples of the solder paste using the flux of the invention will be illustrated. The flux of the invention can be produced using a common method for fabricating solder paste.

The flux (100 wt %) contained 50 wt % acrylic acid-modified rosin as base resin, 30 wt % hexyl diglycol as solvent, 10 wt % hardened castor oil, 3 wt % halogen-based active agent, 2 wt % organic acid, and 5 wt % hydrotalcite. These materials were introduced into the hexyl diglycol one at a time, and are dissolved therein while heating and agitating. The agitation temperature was 120° C. to 200° C. This was cooled after the components had dissolved, yielding the flux. It should be noted that halogen-based active agent refers to an active agent that contains at least one type of halide.

Three types of organic acids were used: glutaric acid, succinic acid, and adipic acid. Also, four types of hydrotalcite-like compounds were used: Mg₆Al₂(OH)₁₆CO₃.4H₂O (hereinafter referred to as “Mg₆—Al₂ based HT”), Mg₄Al₂(OH)₁₂CO₃.3.5H₂O (hereinafter referred to as “Mg₄—Al₂ based HT”), Mg₅Al₂(OH)₁₄CO₃.4H₂O (hereinafter referred to as “Mg₅—Al₂ based HT”), and Mg₃ZnAl₂(OH)₁₂CO₃.wH₂O (hereinafter referred to as “Mg₃—Zn—Al₂ based HT”).

It should be noted that a flux that does not contain hydrotalcite was also prepared as a comparative example. In this case, the composition of the hydrotalcite-like compound was supplemented by increasing the amount of the hexyl diglycol solvent.

Next, these fluxes were used to produce solder paste. The powder alloy used was made of tin-silver-copper alloy (Sn 96.5 wt %, Ag 3.0 wt %, Cu 0.5 wt %) with a particle size of 25 μm to 38 μm.

88.5 wt % of the alloy powder and 11.5 wt % of the flux were mixed together by agitation with a mixer generally used for the fabrication of common solder paste, producing a sample. Herein, the samples using the flux of the invention are called working samples, and the samples in which hydrotalcite had not been added to serve as a comparative example are called comparative samples.

The fabricated solder pastes were evaluated for paste viscosity, electrical reliability, migration, overheating, and voids. The composition of each sample and the results of the tests are shown in Table 1.

TABLE 1

| | | | | | | | | | Comparative | | |
|---|---|---|---|---|---|---|---|---|---|---|---|
| | | | Working Samples | | | | | | Samples | | |
| | | | 1 | 2 | 3 | 4 | 5 | 6 | 1 | 2 | 3 |
| Flux | acrylic | | 50 | 50 | 50 | 50 | 50 | 50 | 50 | 50 | 50 |
| Components | acid-modified | | | | | | | | | | |
| | rosin | | | | | | | | | | |
| | hexyl glycol | | 30 | 30 | 30 | 30 | 30 | 30 | 35 | 35 | 35 |
| | hardened castor oil | | 10 | 10 | 10 | 10 | 10 | 10 | 10 | 10 | 10 |
| | halogen-based | | 3 | 3 | 3 | 3 | 3 | 3 | 3 | 3 | 3 |
| | active agent | | | | | | | | | | |
| | glutaric acid | | 2 | 2 | 2 | 2 | — | — | 2 | — | — |
| | succinic acid | | — | — | — | — | 2 | — | — | 2 | — |
| | adipic acid | | — | — | — | — | — | 2 | — | — | 2 |
| | Mg₆—Al₂ based HT | | 5 | — | — | — | — | — | — | — | — |
| | Mg₄—Al₂ based HT | | — | 5 | — | — | 5 | — | — | — | — |
| | Mg₅—Al₂ based HT | | — | — | 5 | — | — | — | — | — | — |
| | Mg₃—Zn—Al₂ based | | — | — | — | 5 | — | 5 | — | — | — |
| | HT | | | | | | | | | | |
| Test Results | Insulation | After | 8.0 | 9.0 | 8.5 | 8.2 | 8.6 | 7.5 | 0.12 | 0.15 | 0.19 |
| | Resistance | 48 h | | | | | | | | | |
| | (×10⁹ Ω) | After | 8.2 | 8.9 | 8.0 | 8.5 | 8.1 | 7.7 | 6.9 | 5.5 | 6.0 |
| | | 1000 h | | | | | | | | | |
| | Migration | After | 7.0 | 7.2 | 7.5 | 7.2 | 7.3 | 7.8 | 0.16 | 0.12 | 0.17 |
| | (×10⁹ Ω) | 48 h | | | | | | | | | |
| | (no | After | 8.0 | 8.5 | 8.3 | 8.1 | 8.4 | 8.7 | 6.1 | 6.5 | 5.8 |
| | migration | 1000 h | | | | | | | | | |
| | observed) | | | | | | | | | | |
| | Overheat | | 0.2 | 0.2 | 0.2 | 0.2 | 0.2 | 0.2 | 0.4 | 0.4 | 0.4 |
| | Properties 200° C. | | | | | | | | | | |
| | Viscosity | Initial | 205 | 200 | 210 | 205 | 214 | 212 | 200 | 215 | 205 |
| | (Pa · s) | One | 210 | 205 | 200 | 210 | 220 | 210 | 390 | 345 | 350 |
| | 35° C. | Month | | | | | | | | | |

| | | | | | | | | | |
|---|---|---|---|---|---|---|---|---|---|
| Void Rate (%) | 10 | 12 | 10 | 8 | 12 | 10 | 49 | 45 | 40 |

The working samples 1 to 6 are the solder pastes of the invention that contain the flux of the invention. Working samples 1 to 4 have a constant halogen-based active agent and organic acid (glutaric acid) content, and the type of their hydrotalcite-like compound was varied, Mg₆—Al₂ based HT, Mg₄—Al₂ based HT, Mg₅—Al₂ based HT, and Mg₃—Zn—Al₂ based HT, respectively. Working samples 5 and 6 have different combinations of the organic acid and the hydrotalcite-like compound, paired as succinic acid and Mg₄—Al₂ based HT, and adipic acid and Mg₃—Zn—Al₂ based HT, respectively. Comparative samples 1 through 3 are solder pastes that use a conventional flux that does not contain hydrotalcite. Hereinafter, the working samples 1 through 6 may be collectively referred to as the working samples, and the comparative samples 1 through 3 may be collectively referred to as the comparative samples.

Looking at the insulation resistance, the working samples changed little, from 8.0×10⁹ ohms to 9.0×10⁹ ohms, both after 48 hours and after 1000 hours. In contrast, the comparative samples experienced a decrease in resistance to below 1.0×10⁹ ohms at 48 hours and then returned to above 1.0×10⁹ ohms after 1000 hours. However, even this is not as high as in the working samples. This behavior of the comparative samples is likely due to the effects of the halogen-based active agent or the organic acid in the residue. That is, this demonstrates that with the working samples, the flux in the residue does not affect the electrical characteristics.

In the migration test, the insulation resistance was also measured simultaneously. If the insulation resistance value is below 1.0×10⁹ ohms (Ω), it is determined that there is a sign that migration has occurred, even if migration cannot be found by microscope observation. In the comparative samples, the signs of migration appeared after 48 hours had elapsed. However, at 1000 hours the signs of migration had disappeared. The working samples 1 through 4 were stable after 48 hours and 1000 hours and did not show signs of migration, and of course there was no sign of migration either. It should be noted that migration was not observed either in the working samples or in the comparative samples, as indicated in Table 1 in parenthesis.

The measured values of the viscosity when produced initially and after one month are shown. For storage, the paste was put in a bottle and capped, and stored at 35° C. or less. When first produced, all samples were about the same at about 210 (Pa·s). However, comparing these values with those after one month, it can be seen that there was hardly any change in viscosity in the working samples 1 through 6, whereas in all of the comparative samples the viscosity was nearly double.

Comparing the void rates, all the working samples were around 10%, whereas in the comparative samples the void rate increased to around 45%. In other words, the void rate of the working samples is extremely low. Thus, by using the flux of the invention, it is possible to obtain a solder paste with significantly better characteristics, including storability, void rate, and electrical reliability.

It should be noted that whether or not the hydrotalcite-like compound is present in the solder paste can be confirmed as follows. The solder paste is soaked in solvent, and the solder is heated and decomposed. Vegetable oil or animal oil was introduced after decomposition, and to this an organic acid was introduced and heated, after which it was separated into precipitate and supernatant liquid. If the solder paste contains hydrotalcite, it will be present in the precipitate.

The hydrotalcite-like compound can be created from various elements, but it is particularly easy to manufacture when Mg and Al are used. These substances are not present in the solder paste as the components other than the hydrotalcite-like compound, and even if they are, they are present in trace amounts. Thus, when Mg and Al are present in a relatively large quantity in the precipitate that is obtained as discussed above, it is believed that they derive from the hydrotalcite. In other words, if elements such as Mg and Al can be detected in the precipitate that is obtained as above, it can be assumed that the solder paste contains hydrotalcite.

It should be noted that the elements present in the precipitate can be detected by methods such as an X-ray diffraction method, a wavelength dispersive fluorescent X-ray method, or a mass dispersive fluorescent X-ray method.

### Embodiment 2

The flux of the invention can be used in flux cored solder as well as in solder paste. Flux cored solder is solder in which flux has been introduced into the solder. When the flux of the invention is used in flux cored solder, either solvent is not used or is used in tiny quantities. In this example, fluxes for flux cored solder were produced with the following compositions.

The flux (100 wt %) contains 90 wt % acrylic acid-modified rosin as base resin, 3 wt % halogen-based active agent, 2 wt % organic acid, and 5 wt % hydrotalcite. These materials were introduced into an agitator one at a time, and were broken down while heating and agitating. The agitation temperature was 120° C. to 200° C.

Three types of organic acid were used: glutaric acid, succinic acid, and adipic acid. Also, four types of hydrotalcite-like compound were used: Mg₆Al₂(OH)₁₆CO₃.4H₂O (hereinafter, Mg₆—Al₂ based HT), Mg₄Al₂(OH)₁₂CO₃.3.5H₂O (hereinafter, Mg₄—Al₂ based HT), Mg₅Al₂(OH)₁₄CO₃.4H₂O (hereinafter, Mg₅—Al₂ based HT), and Mg₃ZnAl₂(OH)₁₂CO₃.wH₂O (hereinafter, Mg₃—Zn—Al₂ based HT).

It should be noted that a flux that does not contain hydrotalcite was also produced to serve as a comparative example. In this case, the composition of the hydrotalcite-like compound was supplemented by increasing the amount of the acrylic acid-modified rosin serving as the base resin.

Next, these fluxes were used to produce flux cored solder. The alloy used was tin-silver-copper alloy (Sn 96.5 wt %, Ag 3.0 wt %, Cu 0.5 wt %).

The flux was sandwiched in the alloy and this was drawn out into a cylindrical shape to produce a 0.8 mm diameter flux cored solder. At this time, the flux in the center had a diameter of approximately 0.3 mm.

The respective flux cored solders that were produced are referred to as working samples 11 through 16, which use the flux of the invention of this application, and comparative samples 11 through 13. Their electrical reliability was assessed. The composition of each sample and the results are shown in Table 2.

TABLE 2

| | | | | | | | | | Comparative | | |
|---|---|---|---|---|---|---|---|---|---|---|---|
| | | | Working Samples | | | | | | Samples | | |
| | | | 11 | 12 | 13 | 14 | 15 | 16 | 11 | 12 | 13 |
| Flux | acrylic | | 90 | 90 | 90 | 90 | 90 | 90 | 95 | 95 | 95 |
| Components | acid-modified rosin | | | | | | | | | | |
| | halogen-based | | 3 | 3 | 3 | 3 | 3 | 3 | 3 | 3 | 3 |
| | active agent | | | | | | | | | | |
| | glutaric acid | | 2 | 2 | 2 | 2 | — | — | 2 | — | — |
| | succinic acid | | — | — | — | — | 2 | — | — | 2 | — |
| | adipic acid | | — | — | — | — | — | 2 | — | — | 2 |
| | Mg₆—Al₂ based HT | | 5 | — | — | — | — | — | — | — | — |
| | Mg₄—Al₂ based HT | | — | 5 | — | — | 5 | — | — | — | — |
| | Mg₅—Al₂ based HT | | — | — | 5 | — | — | — | — | — | — |
| | Mg₃—Zn—Al₂ based | | — | — | — | 5 | — | 5 | — | — | — |
| | HT | | | | | | | | | | |
| Test Results | Insulation | After | 9.0 | 8.1 | 8.4 | 8.6 | 8.1 | 8.0 | 0.40 | 0.30 | 0.32 |
| | Resistance | 48 h | | | | | | | | | |
| | (×10⁹ Ω) | After | 9.1 | 8.5 | 8.5 | 8.9 | 8.4 | 8.6 | 6.9 | 5.0 | 7.0 |
| | | 1000 h | | | | | | | | | |
| | Migration | After | 7.4 | 7.5 | 7.6 | 7.1 | 7.2 | 7.4 | 0.35 | 0.23 | 0.41 |
| | (×10⁹ Ω) | 48 h | | | | | | | | | |
| | (no | After | 8.1 | 8.3 | 8.4 | 8.4 | 8.1 | 8.6 | 6.4 | 6.9 | 6.6 |
| | migration | 1000 h | | | | | | | | | |
| | observed) | | | | | | | | | | |

The working samples 11 through 16 are flux cored solders of the invention that contain the flux of the invention. Working samples 11 through 14 have a constant halogen-based active agent and organic acid (glutaric acid) content, and the types of the hydrotalcite-like compounds were Mg₆—Al₂ based HT, Mg₄—Al₂ based HT, Mg₅—Al₂ based HT, and Mg₃—Zn—Al₂ based HT, respectively. Working samples 15 and 16 are different combinations of the organic acid and the hydrotalcite-like compound, paired as succinic acid and Mg₄—Al₂ based HT, and adipic acid and Mg₃—Zn—Al₂ based HT, respectively. Comparative samples 11 through 13 are flux cored solders which use a conventional flux that does not contain hydrotalcite.

The flux cored solders of the invention exhibit excellent insulation resistances, stable from 8.0×10⁹ ohms to 9.0×10⁹ ohms both after 48 hours and after 1000 hours. On the other hand, the comparative samples show a change in insulation resistance to below 1.0×10⁹ ohms after 48 hours and then returned to above 1.0×10⁹ ohms after 1000 hours. As in the case of Embodiment 1, with the flux of the invention, the active agent is intercalated after soldering and prevents reaction with the alloy after bonding, and thus the flux of the invention has an advantageous effect on the electrical reliability when used in flux cored solder as well as in solder paste.

A migration test was performed also. As in the case of the solder paste of Embodiment 1, migration was not observed by microscope either in the working samples or in the comparative samples. However, the insulation resistance that was also measured simultaneously was stable in the working samples and stayed above a resistance value of 1.0×10⁹ ohms, whereas in the comparative samples, there were periods where the insulation resistance fell below 1.0×10⁹ ohms, which shows that there is less stability than in the working samples.

It should be noted that in this embodiment, the solder is arranged in a concentric circle around the flux, but it is also possible to adopt a structure in which the flux is disposed at a plurality of locations in a cross section of the flux cored solder, and some of the flux may protrude from the alloy.

As has been described above, the flux cored solder using the flux of the invention prevents a reaction between the active agent and the alloy after bonding, thus making bonding by solder with excellent electrical reliability possible.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

1. A flux comprising a base resin, an active agent, and a layered hydroxide containing hydroxyl groups and metal ions having different valence numbers.

2. The flux according to claim 1, wherein the metal ions are Mg ions and Al ions.

3. The flux according to claim 1, wherein the active agent contains at least one of an organic acid and a halide.

4. The flux according to claim 1, wherein the hydroxide is hydrotalcite.

5. The flux according to claim 4,
wherein the hydrotalcite is expressed by the following Formula (I):
[Mₘ²⁺Mₙ³⁺(OH)₂ₘ₊₂ₙ]X_{n/z}^{z-}.bH₂O (I)
wherein
Mₘ²⁺ is a divalent ion of at least one metal selected from the group consisting of Mg, Ca, Sr, Cu, Ba, Zn, Cd, Pb, Ni, Zr, Co, Fe, Mn, and Sn;
Mₙ³⁺ is a trivalent ion of at least one metal selected from the group consisting of Al, Fe, Cr, Ga, Ni, Co, Mn, V, Ti, and In;
m and n are real numbers;
X_{n/z}^{z-} is a z-valence anion; and
b is a real number.

6. The flux according to claim 5, wherein an acid that produces the anion (X_{n/z}^{z-}) includes at least one of a monobasic acid, a dibasic acid, and a halogen-based compound.

7. The flux according to claim 5, wherein the anion (X_{n/z}^{z-}) is a carbonate ion.

8. The flux according to claim 3, wherein the hydroxide is hydrotalcite.

9. The flux according to claim 8,
wherein the hydrotalcite is expressed by the following Formula (I):
[Mₘ²⁺Mₙ³⁺(OH)₂ₘ₊₂ₙ]X_{n/z}^{z-}.bH₂O (I)
wherein
Mₘ²⁺ is a divalent ion of at least one metal selected from the group consisting of Mg, Ca, Sr, Cu, Ba, Zn, Cd, Pb, Ni, Zr, Co, Fe, Mn, and Sn;
Mₙ³⁺ is a trivalent ion of at least one metal selected from the group consisting of Al, Fe, Cr, Ga, Ni, Co, Mn, V, Ti, and In;
m and n are real numbers;
X_{n/z}^{z-} is a z-valence anion; and
b is a real number.

10. The flux according to claim 9, wherein an acid that produces the anion (X_{n/z}^{z-}) includes at least one of a monobasic acid, a dibasic acid, and a halogen-based compound.

11. The flux according to claim 9, wherein the anion (X_{n/z}^{z-}) is a carbonate ion.

12. The flux according to claim 1, further comprising a solvent.

13. A solder paste comprising solder powder and a flux according to claim 1.

14. The solder paste according to claim 13, wherein the flux further comprises a solvent.

15. A flux cored solder comprising a flux according to claim 1, and a solder alloy disposed around the flux.
